(19) United States
(12) Patent Application Publication
(10) Pub. No.: US 2017/0193371 A1
(43) Pub. Date: Jul. 6, 2017

(54) PREDICTIVE ANALYTICS WITH STREAM DATABASE

(71) Applicant: CISCO TECHNOLOGY, INC., San Jose, CA (US)

(72) Inventors: Zhitao Shen, Shanghai (CN); Vikram Kumaran, Cary, NC (US); David Tang, Shanghai (CN); Hao Liu, Shanghai (CN)

(73) Assignee: CISCO TECHNOLOGY, INC., San Jose, CA (US)

(21) Appl. No.: 14/985,790

(22) Filed: Dec. 31, 2015

(51) Int. Cl. G06N 5/04; G06F 17/30; G06N 99/00

(52) U.S. Cl. CPC G06N 5/04; G06N 99/005; G06F 17/30516

(57) ABSTRACT

In one embodiment, a method includes receiving a data stream at an analytics device, applying at the analytics device, continuous streaming queries to the data stream to build a plurality of models simultaneously for a plurality of time windows, each of the models comprising an incremental machine learning algorithm with parameters optimized for one of the time windows, validating the models in parallel using real-time data at the analytics device, selecting at least one of the models based on a comparison of validation results for the models, and applying the selected model to the real-time data to generate a data prediction at the analytics device. An apparatus and logic are also disclosed herein.

### TECHNICAL FIELD

The present disclosure relates generally to communication networks, and more particularly, to predictive analytics with stream databases.

### BACKGROUND

Streaming database systems are popular engines that process event/telemetry streams coming from cyber/physical systems. These streaming databases are adept at handling data in motion and have wide uses for IoT (Internet of Things) analytics.

### BRIEF DESCRIPTION OF THE FIGURES

FIG. 1 illustrates an example of a network in which embodiments described herein may be implemented.

FIG. 2 depicts an example of a network device useful in implementing embodiments described herein.

FIG. 3 is a flowchart illustrating an overview of a process for predictive analytics, in accordance with one embodiment.

FIG. 4 is a block diagram illustrating an example of a predictive analytics system, in accordance with one embodiment.

FIG. 5 illustrates a sliding time window over which a predictive model is generated, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises receiving a data stream at an analytics device, applying at the analytics device, continuous streaming queries to the data stream to build a plurality of models simultaneously for a plurality of time windows, each of the models comprising an incremental machine learning algorithm with parameters optimized for one of the time windows, validating the models in parallel using real-time data at the analytics device, selecting at least one of the models based on a comparison of validation results for the models, and applying the selected model to the real-time data to generate a data prediction at the analytics device.

In another embodiment, an apparatus generally comprises a model distributor operable to process data streams according to continuous streaming queries, a modeler operable to build a plurality of models simultaneously for a plurality of time windows, each of the models comprising an incremental machine learning algorithm with parameters optimized for one of the time windows, a model validator operable to validate the models using real-time data and select at least one of the models based on a comparison of validation results for the plurality of models, and a model predictor operable to apply the selected model to the real-time data to generate a data prediction.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

One of the defining characteristics of streaming data is the constant change of context. Streaming data sources produce data that is constantly evolving and changing. The underlying baseline continues to change as the physical systems face varying circumstances. Incremental machine learning may be used to take context evolution into account to constantly modify and adapt machine learning models over time.

The embodiments described herein provide a platform to run incremental predictive analytics in a stream database. One or more embodiments allow machine learning algorithms to be adapted to work in an incremental fashion. Models may evolve as new data arrives and the effects of older events on the model may automatically decrease. Certain embodiments leverage platform constructs provided by streaming database systems to implement incremental machine learning algorithms easily and efficiently. As described in detail below, on-the-fly model training may be provided for multiple machine learning algorithms as part of a streaming relational database system. In one or more embodiments, in-database predictive analytics may be enabled so that relational operators SQL (Structured Query Language) may be supported natively.

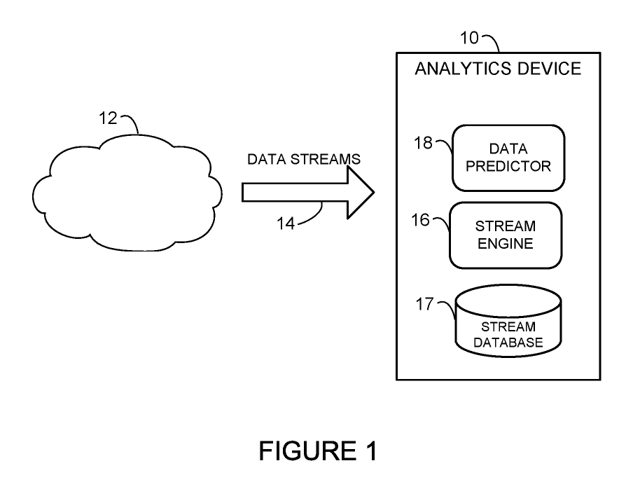

Referring now to the drawings, and first to FIG. 1, a simplified network in which embodiments described herein may be implemented is shown. The embodiments operate in the context of a data communication network including multiple network devices. The network may include any number of network devices in communication via any number of nodes (e.g., routers, switches, gateways, controllers, access devices, aggregation devices, core nodes, intermediate nodes, or other network devices), which facilitate passage of data within the network. The nodes may communicate over one or more networks (e.g., local area network (LAN), metropolitan area network (MAN), wide area network (WAN), virtual private network (VPN), virtual local area network (VLAN), wireless network, enterprise network, Internet, intranet, radio access network, public switched network, or any other network).

The network shown in the example of FIG. 1 includes an analytics device (network device, computing device) 10 configured for receiving data from network 12. The data may comprise, for example, one or more data streams 14, which may be provided to the analytics device 10 in any suitable format. Streaming data may come from many different sources. For example, the streaming data may be from sensors or machines in a factory environment, cars and sensors on the road, telemetry from network devices, or any other source, sensor, or monitor. As noted above, the data's statistical properties are constantly changing based on the physical context and thus the data stream is an unbounded sequence of tuples (i.e., set of data).

As shown in the example of FIG. 1, the analytics device 10 includes a stream engine 16, stream database (streaming database) 17 and a data predictor 18 operable to provide predictive analytics, as described in detail below. The stream engine 16 is operable to process data streams 14 received at the analytics device 10. The stream database 17 is similar to a traditional database in feature-set with extensions to process real-time events as they arrive. The stream database 17 may, for example, process events in memory before the data is stored. In certain embodiments, the stream database 17 is operable to process time/logically constrained windows of data tuples.

The analytics device 10 may comprise a controller, server, appliance, or any other network element or general purpose computing device located in a network or in a cloud or fog environment. One or more components shown at the analytics device 10 in FIG. 1 may be located at another network device or distributed in the network.

In one example, the analytics device 10 may pull live stream data 14 from an edge device or operate at an edge device. The analytics device 10 may, for example, communicate with a plurality of edge devices either directly or through one or more intermediate devices (not shown). The analytics device 10 may receive stream data coming from sensors or other computers (e.g., one or more edge devices in communication with one or more sensors). Data may be received from multiple sources or a single source. In certain embodiments, the analytics device 10 may leverage one or more application programming interfaces (APIs) to access multiple data streams 14. The analytics device 10 may also one have one or more connected output devices.

The analytics device 10 may process raw data from a variety of sensors and provide processed data. Sensors may include, for example, accelerometers, gyroscopes, magnetometer, cameras, seismic detectors, temperature sensors (e.g., thermistors, thermocouples), speedometers, pedometers, location sensors, light detectors, weather detectors, event emitters for statistics (e.g., CPU usage, bandwidth, Input/Output operations), sensors for determining whether a system or process is running, or any other sensor operable to measure, gauge, sense, detect, or determine any other parameter, variable, or value.

In certain embodiments, the analytics device 10 may process data for one or more continuous streaming queries. The continuous streaming query may be used to pull live stream data from the network 12 (or one or more components within the network). The continuous streaming query may apply traditional query operators, such as aggregators, predicates, and joins, to a live data stream to produce a result set of attributes. The continuous query may have additional parameters to constrain how the query pulls data over time. For example, the continuous query may have a time interval parameter constraining the range of time for which the query will collect data. The continuous query may also have a frequency or period parameter defining how often the query pulls data. The continuous query may be executed by accepting data from multiple sources or a single source.

As described in detail below, the data predictor 18 may be used to create multiple predictive models dynamically and in parallel and use the data stream 14 to validate the models. The models may evolve as new data arrives and the effects of the older events on the model automatically decrease. The data predictor 18 leverages platform constructs provided by the stream database 17 to implement incremental machine learning algorithms. Since the system is operating on a real-time stream of data, models are continuously being updated based on recent past so that the system is sensitive to context evolution, unlike batch approaches.

The time series data streams 14 may have short term correlations and context evolution over longer time-horizons. Machine learning algorithms may be used to detect anomalies or predict near-future events. In order to predict near future values (e.g., five minutes (or other time period)), the algorithms are modeled on recent data. As the context changes, multiple algorithms (models) may be run. As described in detail below, while the system handles the temporal aspects of time windows, the machine learning algorithms handle the modeling of the data. The system's streaming capabilities are used to send appropriate data corresponding to a time window to a modeler to only consider recent context and thus provide improved prediction accuracy.

It is to be understood that the network and computing device shown in FIG. 1 and described above is only an example and the embodiments described herein may be implemented in networks comprising different network topologies or network devices, or using different protocols or languages, without departing from the scope of the embodiments. For example, the network may include any number or type of network devices that facilitate passage of data over the network (e.g., routers, switches, gateways, controllers), network elements that operate as endpoints or hosts (e.g., servers, virtual machines, clients), and any number of network sites or domains in communication with any number of networks. Thus, network nodes may be used in any suitable network topology, which may include any number of servers, accelerators, virtual machines, switches, routers, appliances, controllers, or other nodes interconnected to form a large and complex network, which may include cloud or fog computing. Nodes may be coupled to other nodes through one or more interfaces employing any suitable wired or wireless connection, which provides a viable pathway for electronic communications. Also, as noted above, components of the analytic device may be located at separate devices or distributed throughout the network.

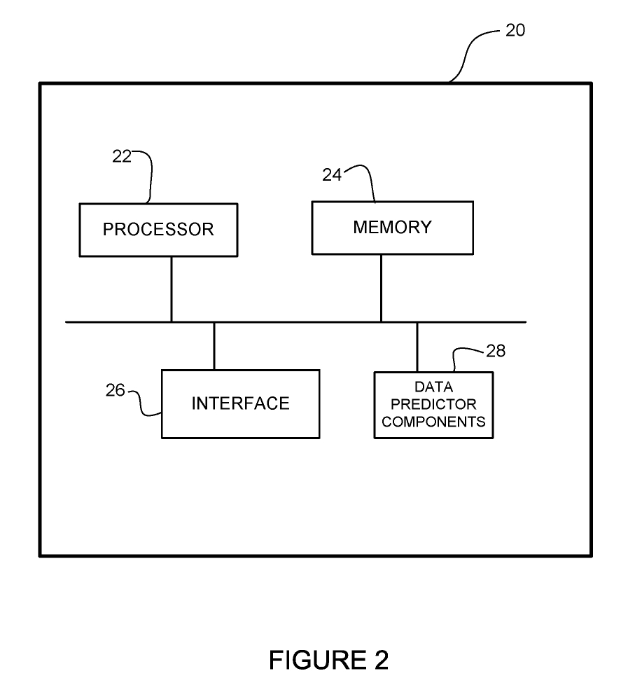

FIG. 2 illustrates an example of a network device 20 (e.g., analytics device 10 in FIG. 1) that may be used to implement the embodiments described herein. In one embodiment, the network device 20 is a programmable machine that may be implemented in hardware, software, or any combination thereof. The network device 20 includes one or more processor 22, memory 24, network interface 26, and data predictor components 28 (e.g., model distributor, modeler, model validator, model predictor).

Memory 24 may be a volatile memory or non-volatile storage, which stores various applications, operating systems, modules, and data for execution and use by the processor 22. Memory 24 may include, for example, one or more databases (e.g., stream database 17 or any other data structure configured for storing data, models, policies, functions, algorithms, variables, parameters, network data, or other information. One or more data predictor components 28 (e.g., code, logic, software, firmware, etc.) may also be stored in memory 24. The network device 20 may include any number of memory components.

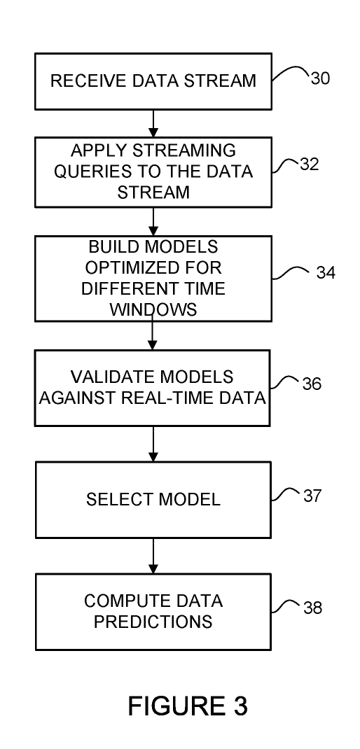

Logic may be encoded in one or more tangible media for execution by the processor 22. The processor 22 may be configured to implement one or more of the functions described herein. For example, the processor 22 may execute codes stored in a computer-readable medium such as memory 24 to perform the process described below with respect to FIG. 3. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium. In one example, the computer-readable medium comprises a non-transitory computer-readable medium. The network device 20 may include any number of processors 22.

The network interface 26 may comprise any number of interfaces (linecards, ports) for receiving data or transmitting data to other devices. The network interface 26 may include, for example, an Ethernet interface for connection to a computer or network. The network interface 26 may be configured to transmit or receive data using a variety of different communication protocols. The interface 26 may include mechanical, electrical, and signaling circuitry for communicating data over physical links coupled to the network.

It is to be understood that the network device 20 shown in FIG. 2 and described above is only an example and that different configurations of network devices may be used. For example, the network device 20 may further include any suitable combination of hardware, software, algorithms, processors, devices, components, modules, or elements operable to facilitate the capabilities described herein.

FIG. 3 is a flowchart illustrating an overview of a process for predictive analytics, in accordance with one embodiment. At step 30, an analytics device (e.g., network device 10 in FIG. 1 or any combination of network or computing devices) receives one or more data streams 14. Continuous streaming queries are applied to the data stream (step 32) to build a plurality of models simultaneously (i.e., in parallel at approximately the same time) for a plurality of time windows (sliding time windows) (step 34). Each of the models comprises an incremental machine learning algorithm with different parameters optimized for one of the windows. The models are validated in parallel using real-time data (time series streaming data 14) at the analytics device 10 (step 36). At least one of the models (e.g., 1, 2, 3, . . . models, group or set of models, high ranked models (i.e., models at the top of a ranking)) is selected based on a comparison of the validation results for the models (step 37). For example, a model that best predicts or indicates action trends in data may be selected based on a rank or validation score. The selected model is applied to the real-time data to generate a data prediction at the analytics device 10 (step 38). The model (mathematical formula) may be computed as real-time data arrives from the data stream to produce a prediction of the value of interest in the near future. The results may comprise, for example, a continuous stream of values at a specified offset in time from the current time. As described below, the models may be continuously updated based on recent data so that the system is sensitive to context changes.

It is to be understood that the process shown in FIG. 3 and described above is only an example and that steps may be added, combined, or modified without departing from the scope of the embodiments.

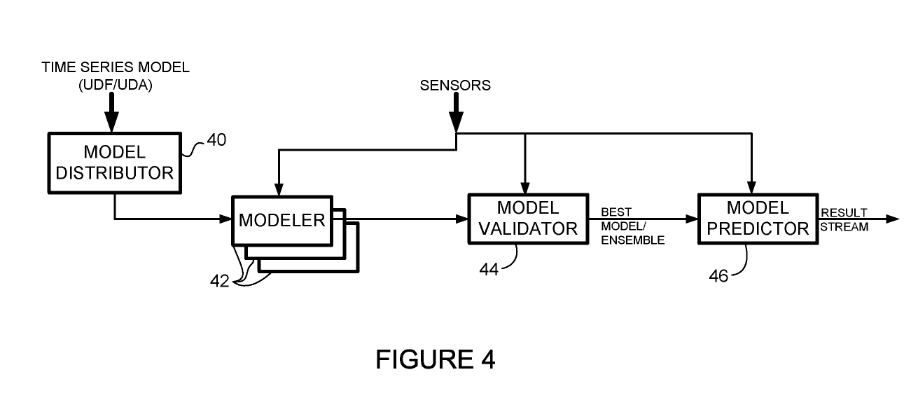

FIG. 4 is a block diagram illustrating a predictive analytics stream database system, in accordance with one embodiment. In this example, the system comprises a model distributor 40, plurality of modelers 42, model validator 44, and model predictor 46. Time series models (e.g., UDF/UDA (User Defined Functions/User Defined Aggregates) are input to the model distributor 40 and sensor data is provided to the modelers 42, model validator 44, and model predictor 46, as described below.

The model distributer 40 creates multiple streaming queries that use different time windows and thus different values for the history used in the model to create slightly different models with different optimized parameters. The modelers 42 then use the continuous queries from the model distributor 40 to build models for specific time window lengths, as specified in each query. The model validator 44 uses the set of models built by the modelers 42 and applies the models against the data stream as new values (real-time data) arrive to test the model predictions based on the new values. The model validator 44 then outputs a single model or a top few models that can be combined as an ensemble. The model predictor 46 takes the model (or set of models) produced by the model validator 44 and outputs a resultant stream comprising a continuous stream of values at a specified offset in the future. Since the system is operating on a real-time stream of data, models are continuously updated based on recent data so that the system is sensitive to context evolution. In certain embodiments, the number of models or time window lengths may be user configured.

The following describes an example embodiment in which three UDF (User Defined Functions)/UDA (User Defined Aggregates) are used for each type of time series models. In this example, the time series (TS) functions comprise:
build_TS(event[ ], window_length)—returns a <model>;
validate_TS(<model>, events[ ])—returns a stream score that quantifies the accuracy of the model; and
predict_TS(event[ ], <model>, time-in-future)—returns a prediction for the given time-in-future.

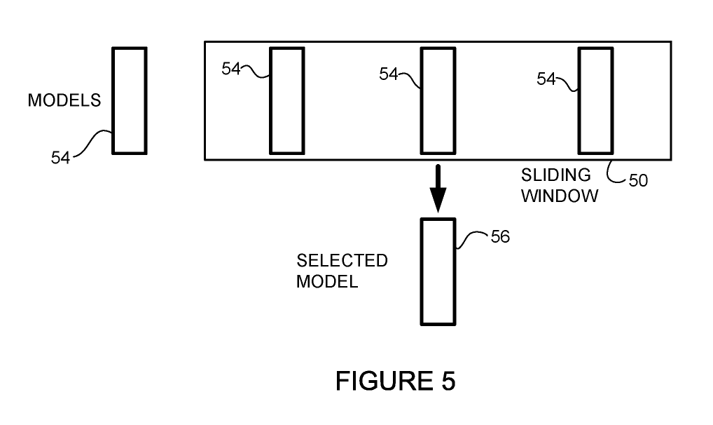

The model distributor 40 (FIG. 4) uses the native continuous streaming query capability to initiate multiple streaming queries to build models against multiple time windows simultaneously and in parallel, as described further below with respect to FIG. 5. Time series models may have parameters that are dependent on the amount of history considered in the model (window size). In one example, the time series model may use three parameters (e.g., p, q, d), which are functions of the number of data points in the history that will be considered (e.g., as used in ARIMA (Autoregressive Integrated Moving Average) models). The embodiments are not limited to ARIMA models and may be used with other models that utilize parameters that are dependent on the number of points in history considered. The model distributor 40 creates multiple streaming queries that use different time windows and hence different values for the history considered in the model, thus creating slightly differing models with different optimized parameters. The streaming capabilities may be used to send appropriate time window data to the modelers 42 to only consider recent context to provide better prediction accuracy.

The models are provided to modelers 42, which apply the models to different time windows. As previously described, the system may run multiple algorithms (modelers 42), while also addressing the temporal aspects of time windows. The machine learning algorithms only need to deal with the modeling of the data and not the time window aspects. The modelers 42 each comprise a continuous query that builds a model for a specific time window length, as specified in the query. The query is a single instance of many instances created by the model distributor 40. The modeler 42 optimizes the model for the specified time window. In one example, the modeler 42 runs a ‘build_TS’ UDF/UDA and returns the optimized parameters for the model in a data structure that is the input parameter for the ‘validate_TS’ and ‘predict_TS’ functions. The parameters are optimized for a specific time window.

The model validator 44 determines which model provides the best prediction based on actual data. For example, given a set of models built by the modelers 42, the model validator 44 may apply the models against the data stream as new values arrive from the sensors, and test the model predictions for the new values using the ‘validate_TS’ function. The result of the query is to rank the different models based on the accuracy/ranking measure implemented in the ‘validate_TS’ function and return either a single model or a top few models that can be combined as an ensemble model to generate a prediction.

The model generated by the model validator 44 is input at the model predictor 46, which outputs a resultant stream using the selected model. The model is a mathematical formula that can be computed as data arrives from the stream to produce prediction of the value of interest in the near future. The model predictor 46 may use the ‘predict_TS’ function to compute the model as specified by the model validator 44. The results are a continuous stream of values at a specified offset in the future from the current time.

As can be observed from the foregoing, the system shown in FIG. 4 may use the stream engine 16 (FIG. 1) to implement incremental learning algorithms on time series data that can produce the best model to predict the near future. The embodiments may be applied to many different time series prediction algorithms. Various conditions and model configurations may be tested in real-time in order to pick the best model, which may continuously improve and evolve with context as conditions change.

FIG. 5 illustrates an example of a sliding window 50 that may be used by the system shown in FIG. 4. The machine learning algorithms (modelers 42 in FIG. 4) build models 54. As previously described, at least one of the models within the time window 50 is selected based on a comparison of validation results for the plurality of models. The selected model 56 is applied to real-time data to generate a data prediction at the analytics device 10 (FIGS. 1 and 5).

The embodiments described herein may be used, for example, as a checkout optimizer (e.g., in retail). In this example, algorithms predicting the length of a checkout queue based on time series checkout data may be run. The checkout line length may be context sensitive so a continuously improving prediction is important. In another example, the system may be used to detect energy consumption (e.g., in manufacturing). In this example, algorithms may be used that predict energy consumption of devices based on time series of current and recent usage. In yet another example, the system may be used to detect a temperature trend in a well (e.g., oil or gas). In this example, sensors in well heads measure temperature at various depths at regular frequency and the system may be used for algorithms that predict temperature trends at different depths. It is to be understood that the above are only examples of implementation and the embodiments described herein may be used in other environments or applications, without departing from the scope of the embodiments.

As can be observed from the foregoing, one or more embodiments described herein provide numerous advantages. For example, certain embodiments provide a generic system as the necessary model build/test/predict UDA/UDFs are provided. Certain embodiments provide continuous improvement of model parameters as the time series attributes and properties change over longer periods of time. The model improvement is a continuous process, as new models are created and validated within the system with data in motion. The embodiments may be used to automatically select the best among a set of possible models since it is building multiple models in parallel and comparing them in real-time with incoming streaming data.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving a data stream at an analytics device;
applying at the analytics device, continuous streaming queries to the data stream to build a plurality of models simultaneously for a plurality of time windows, each of said plurality of models comprising an incremental machine learning algorithm with parameters optimized for one of said plurality of time windows;
validating said plurality of models in parallel using real-time data at the analytics device;
selecting at least one of said plurality of models based on a comparison of validation results for said plurality of models; and
applying said at least one selected model to said real-time data to generate a data prediction at the analytics device.

2. The method of claim 1 further comprising dynamically modifying said plurality of models as conditions change over time.

3. The method of claim 1 wherein the analytics device comprises a stream database.

4. The method of claim 1 wherein said plurality of models are built utilizing UDFs/UDAs (User Defined Functions/User Defined Aggregates).

5. The method of claim 1 further comprising ranking said plurality of models based on said comparison of validation results.

6. The method of claim 5 wherein selecting comprises selecting high ranked models and combining said high ranked models for use in generating said data prediction.

7. The method of claim 1 further comprising continuously updating said plurality of models based on said real-time data.

8. The method of claim 1 wherein UDFs/UDAs (User Defined Functions/User Defined Aggregates) are used to validate said plurality of models and generate said data prediction.

9. The method of claim 1 wherein each of said plurality of time windows covers a plurality of said models.

10. The method of claim 9 wherein selecting at least one of said plurality of models comprises selecting a set of models and generating a final predictive model from said set of models.

11. An apparatus comprising:
a model distributor operable to process data streams according to continuous streaming queries;
a modeler operable to build a plurality of models simultaneously for a plurality of time windows, each of said plurality of models comprising an incremental machine learning algorithm with parameters optimized for one of said plurality of time windows;
a model validator operable to validate said plurality of models using real-time data and select at least one of said plurality of models based on a comparison of validation results for said plurality of models; and
a model predictor operable to apply said at least one selected model to said real-time data to generate a data prediction.

12. The apparatus of claim 11 further comprising a stream database operable to process said real-time data and memory for storing said processed data.

13. The apparatus of claim 11 wherein the modeler is further operable to dynamically modify said plurality of models as conditions change over time.

14. The apparatus of claim 11 wherein said plurality of models are built utilizing UDFs/UDAs (User Defined Functions/User Defined Aggregates).

15. The apparatus of claim 11 wherein the model validator is further operable to rank said plurality of models based on said comparison of validation results.

16. Logic encoded on one or more non-transitory computer readable media for execution and when executed operable to:
process a data stream;
apply continuous streaming queries to the data stream to build a plurality of models simultaneously for a plurality of time windows, each of said plurality of models comprising an incremental machine learning algorithm with parameters optimized for one of said plurality of time windows;
validate said plurality of models using real-time data;
select at least one of said plurality of models based on a comparison of validation results for said plurality of models; and
apply said at least one selected model to said real-time data to generate a data prediction at the analytic device.

17. The logic of claim 16 further operable to dynamically modify said plurality of models based on said real-time data.

18. The logic of claim 16 further operable to rank said plurality of models based on said comparison of validation results.

19. The logic of claim 16 wherein said plurality of models are built utilizing UDFs/UDAs (User Defined Functions/User Defined Aggregates).

20. The logic of claim 16 wherein each of said plurality of time windows covers a plurality of models.
